(19) United States
(12) Patent Application Publication
(10) Pub. No.: US 2015/0279282 A1
(43) Pub. Date: Oct. 1, 2015

(54) DISTRIBUTED ELECTROSTATIC ACTUATOR FOR MEMS DEVICES

(71) Applicant: PIXTRONIX, INC., San Diego, CA (US)

(72) Inventors: Nikolay I. Nemchuk, Andover, MA (US); Tyler A. Dunn, North Reading, MA (US); Mark B. Andersson, Northborough, MA (US); Joyce H. Wu, Somerville, MA (US)

(21) Appl. No.: 14/229,582

(22) Filed: Mar. 28, 2014

(51) Int. Cl. G09G 3/34; G02B 26/04

(52) U.S. Cl. CPC G09G 3/346; G02B 26/04

(57) ABSTRACT

This disclosure provides systems, methods and apparatus for shutter-based EMS light modulators controlled by electrode actuators that include a compliant inner beam electrode positioned between a movable beam electrode and a fixed beam electrode. A first voltage is applied to the movable beam electrode, and a sufficiently different voltage is applied to one of the compliant beam electrode and the fixed outer beam electrode. During actuation, the movable beam electrode is drawn towards the compliant inner beam electrode, while the combination of the movable beam electrode and the compliant inner beam electrode are further drawn to the fixed beam electrode.

### TECHNICAL FIELD

This disclosure relates to the field of displays, and in particular, electromechanical systems (EMS) display elements.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display apparatus. The display apparatus includes a movable light blocking component, a first beam electrode, a second beam electrode, and a third beam electrode. The first beam electrode is coupled to the movable light blocking component and is capable of receiving a first voltage. The second beam electrode is capable of receiving a second voltage, and the third beam electrode is capable of receiving a third voltage. The third beam electrode has a greater degree of mechanical compliance than at least one of the first beam electrode and the second beam electrode. The third beam electrode is positioned between the second beam electrode and at least a portion of the first beam electrode. The first voltage is sufficiently different from at least one of the second voltage and the third voltage to cause the first, second, and third beam electrodes to be drawn substantially into contact with one another, thereby moving the movable light blocking component.

In some implementations, the first voltage can be substantially similar to the second voltage. In some implementations, the second beam electrode can be substantially rigid. In some implementations, the third beam electrode can have a greater degree of mechanical compliance than both the first beam electrode and the second beam electrode.

In some implementations, the first beam electrode and the second beam electrode can be electrically coupled to, and supported over, a substrate by a common anchor. In some implementations, the first beam electrode can include a first portion positioned on a side of the third beam electrode opposite from the second beam electrode. The first beam electrode can also include a second portion positioned on a side of the second beam electrode opposite the third beam electrode.

In some implementations, the third beam electrode can be positioned, in its rest position, approximately halfway between the first and second beam electrodes.

In some implementations, the movable light blocking component can translate radially responsive to the first, second and third beam electrodes being drawn substantially into contact with one another.

In some implementations, the display apparatus can include a display, a processor and a memory device. The processor can be configured to communicate with the display and process image data. The memory device can be configured to communicate with the processor. In some implementations, the display apparatus can also include a driver circuit and a controller. The driver circuit can be configured to send at least one signal to the display. The controller can be configured to send at least a portion of the image data to the driver circuit. In some implementations, the display apparatus includes an image source module that can be configured to send the image data to the processor. The image source module can include at least one of a receiver, transceiver, and transmitter. In some implementations, the display apparatus can include an input device. The input device can be configured to receive input data and to communicate the input data to the processor.

Another innovative aspect of the subject matter described in this disclosure can be implemented in a method of actuating a movable light blocking component. The method includes receiving, by a first beam electrode coupled to the movable light blocking component, a first voltage. The method includes receiving, by a second beam electrode, a second voltage. The method includes receiving, by a third beam electrode positioned between the second beam electrode and at least a portion of the first beam electrode, a third voltage. The third beam electrode has a greater degree of mechanical compliance than at least one of the first and second beam electrodes. The method includes moving the light blocking component by drawing the first, second, and third beam electrodes substantially into contact with one another responsive to the first voltage being sufficiently different from at least one of the second voltage and the third voltage.

In some implementations, the first voltage can be substantially similar to the second voltage, and the third voltage can be sufficiently different from the first voltage and the second voltage. In some implementations, the third beam electrode can have a greater degree of mechanical compliance than both the first beam electrode and the second beam electrode.

In some implementations, the method includes radially translating the movable light blocking component responsive to the first, second and third beam electrodes being drawn substantially into contact with one another.

Another innovative aspect of the subject matter described in this disclosure can be implemented in an apparatus. The apparatus includes a movable light blocking component configured to radially translate. The apparatus includes a first beam electrode coupled to the movable light blocking component. The first beam electrode is capable of receiving a first voltage. The apparatus includes a second beam electrode capable of receiving a second voltage. The apparatus includes a third beam electrode capable of receiving a third voltage and positioned between the second beam electrode and at least a portion of the first beam electrode. The first voltage is sufficiently different from at least one of the second voltage and the third voltage to cause the first, second, and third beam electrodes to be drawn substantially into contact with one another, thereby radially translating the movable light blocking component.

In some implementations, the first voltage can be substantially similar to the second voltage. In some implementations, the third beam electrode can have a greater degree of mechanical compliance than both the first and second beam electrodes. In some implementations, the second beam electrode can be substantially rigid.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCD), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIGS. 3A and 3B show an example actuator in actuated and actuated states, respectively.

FIGS. 4A and 4B show an example actuator in unactuated and actuated states, respectively.

FIGS. 5A and 5B show an example light modulator in unactuated and actuated states, respectively.

FIGS. 6A and 6B show an example light modulator in unactuated am actuated states, respectively.

FIGS. 7A and 7B show an example light modulator in unactuated and actuated states, respectively.

FIGS. 8A and 8B show an example actuator in unactuated and actuated states, respectively.

FIG. 9 shows a flow diagram of an example method of actuating an actuator.

FIGS. 10A and 10B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Shutter-based EMS displays that include light modulators controlled by electrode actuators that typically include a movable outer beam electrode and a fixed outer beam electrode can be fabricated to include a compliant inner beam electrode positioned between the movable outer beam electrode and the fixed outer beam electrode. Two of the beam electrodes receive a common voltage and one of the beam electrodes receives a significantly different voltage. When the significantly different voltage is applied, the movable outer beam electrode is pulled towards the compliant inner beam electrode positioned halfway between the movable outer beam electrode and the fixed outer beam electrode. Further, the compliant inner beam electrode has a greater mechanical compliance than the movable outer beam electrode and the fixed outer beam electrode. As a result, the movable outer beam electrode and the compliant inner beam electrode are pulled substantially into contact with the fixed outer beam electrode.

Particular implementations of the subject matter described in this disclosure can be implemented to realize one or more of the following potential advantages. In some implementations, including an additional beam electrode positioned halfway between a first beam electrode and second beam electrode can result in a reduced actuation voltage because the distance between beam electrodes is less. In some implementations, the additional beam electrode can result in an increase in actuation force or speed for a given actuation voltage.

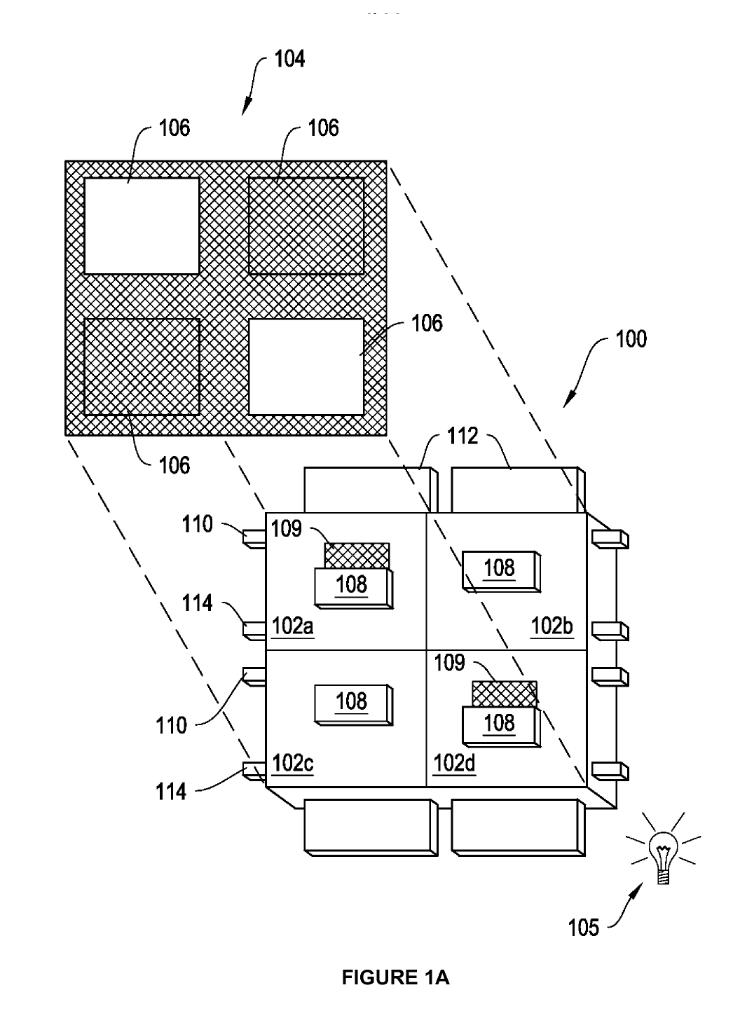

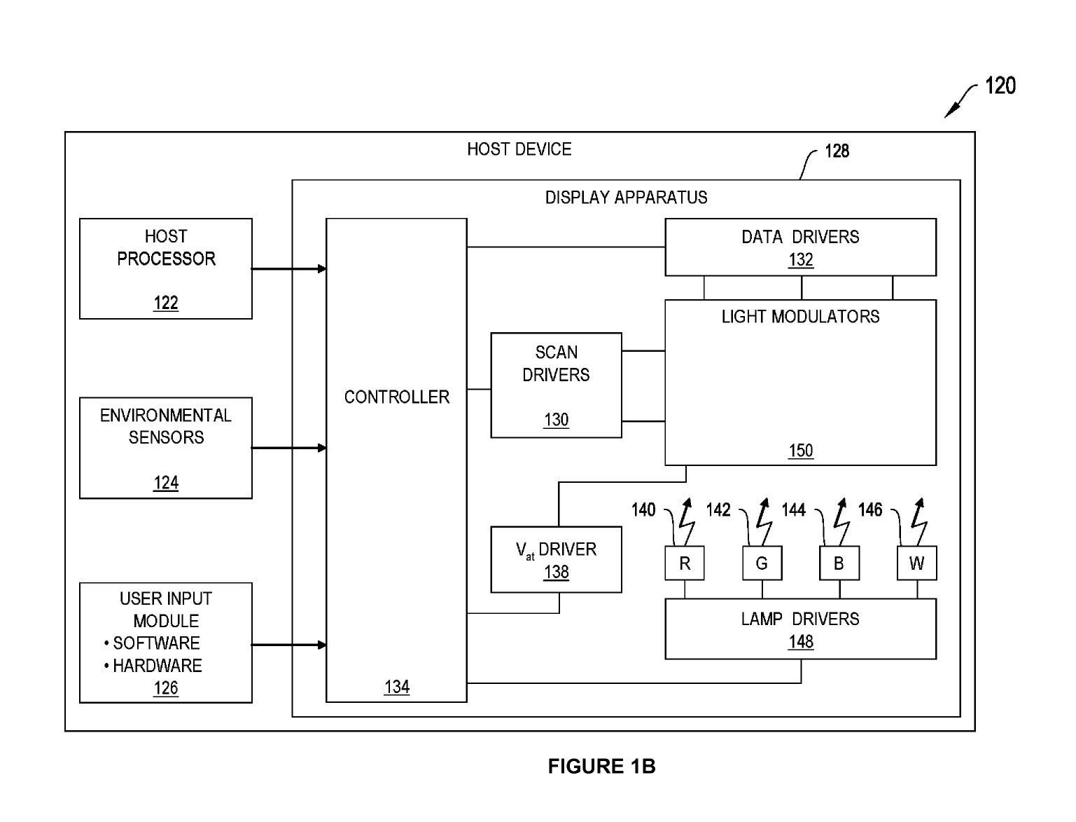

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (e.g., interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, VWE”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in sequences, which in some implementations can be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (e.g., scan drivers 130, data drivers 132 and common drivers 138) for different display functions are time-synchronized by the controller 134. Timing commands from the controller coordinate the illumination of red, green and blue and white lamps (140, 142, 144 and 146 respectively) via, lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to anew image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5th row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

In some implementations the functionality of the controller 134 is divided between a microprocessor and a display controller integrated circuit. In some implementations, the display controller integrated circuit is implemented in an integrated circuit logic device, such as an application specific integrated circuit (ASIC). In some implementations, the microprocessor is configured to carry out all or substantially all of the image processing functionality of the controller 134, as well as determining an appropriate output sequence for the display apparatus 128 to use to generate received images. For example, the microprocessor can be configured to convert image frames included in the received image data into a set of image subframes. Each image subframe is associated with a color and a weight, and includes desired states of each of the display elements in the array 150 of display elements. The microprocessor can also can be configured to determine the number of image subframes to display to produce a given image frame, the order in which the image subframes are to be displayed, and parameters associated with implementing the appropriate weight for each of the image subframes. These parameters may include, in various implementations, the duration for which each of the respective image subframes is to be illuminated and the intensity of such illumination. These parameters (e.g., the number of subframes, the order and timing of their output, and their weight implementation parameters for each subframe) can be collectively referred to as an “output sequence.”

In contrast, the display controller integrated circuit can be configured primarily to carry out more routine operations of the display apparatus 128. The operations may include retrieving image subframes from a frame buffer and outputting control signals to the scan drivers 130, the data drivers 132, the common drivers 138, and the lamp drivers 148, in response to the retrieved image subframe and the output sequence determined by the microprocessor. The frame buffer can be any volatile or non-volatile integrated circuit memory, such as dynamic random access memory (DRAM), high-speed cache memory, or flash memory. In some other implementations, the display controller integrated circuit causes the frame buffer to output data signals directly to the various drivers 130, 132, 138, and 148.

In some other implementations, the functionality of the microprocessor and the display controller integrated circuit described above are combined into a single logic device such as the controller 134, which may take the form of a microprocessor, an ASIC, a field programmable gate array (FPGA) or other programmable logic device. In some other implementations, the functionality of the microprocessor and the display controller integrated circuit may be divided in other ways between multiple logic devices, including one or more microprocessors, ASICs, FPGAs, digital signal processors (DSPs) or other logic devices.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the lost, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

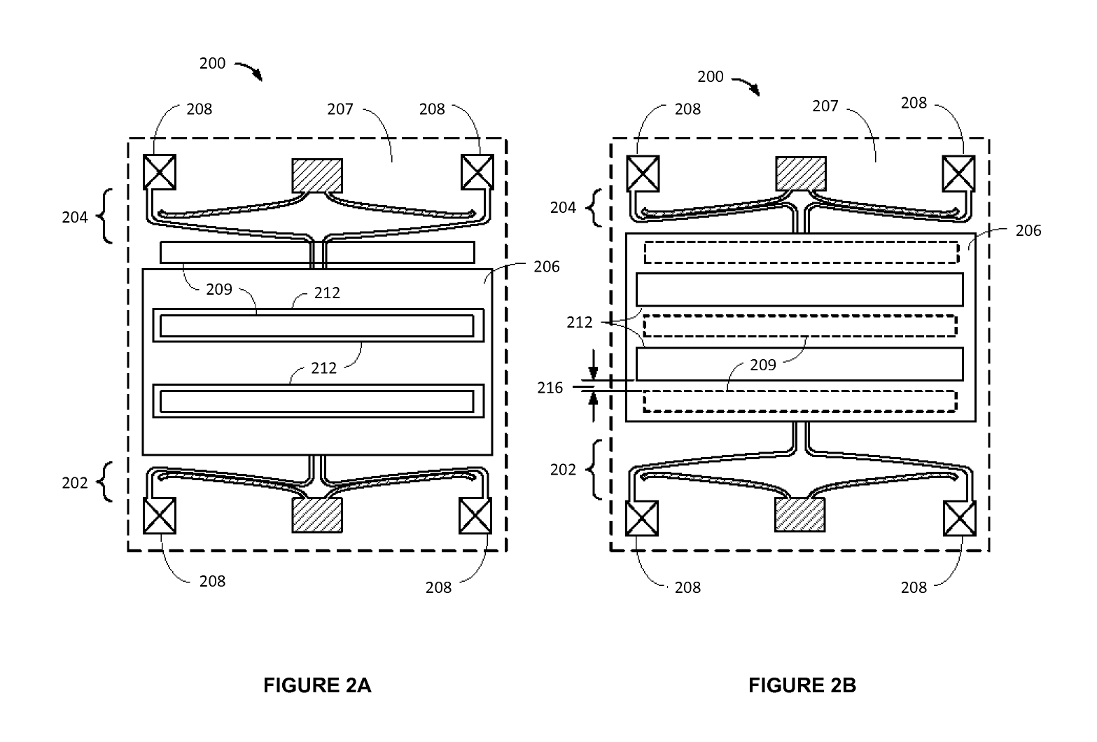

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Both of the actuators 202 and 204 are compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. The inclusion of supports attached to both ends of the shutter 206 along its axis of movement reduces out of plane motion of the shutter 206 and confines the motion substantially to a plane parallel to the substrate. A control matrix suitable for use with the shutter assembly 200 might include one transistor and one capacitor for each of the opposing shutter-open and shutter-close actuators 202 and 204.

The shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In alternative implementations in which circular, elliptical, oval, or other curved apertures are formed in the aperture layer 207, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 212 and 209 in the open state, it is advantageous to provide a width or size for shutter apertures 212 which is larger than a corresponding width or size of apertures 209 in the aperture layer 207. In order to effectively block light from escaping in the closed state, it is preferable that the light blocking portions of the shutter 206 overlap the apertures 209. FIG. 2B shows a predefined overlap 416 between the edge of light blocking portions in the shutter 206 and one edge of the aperture 209 formed in the aperture layer 207.

The electrostatic actuators 202 and 204 are designed so that their voltage displacement behavior provides a bi-stable characteristic to the shutter assembly 200. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vm.

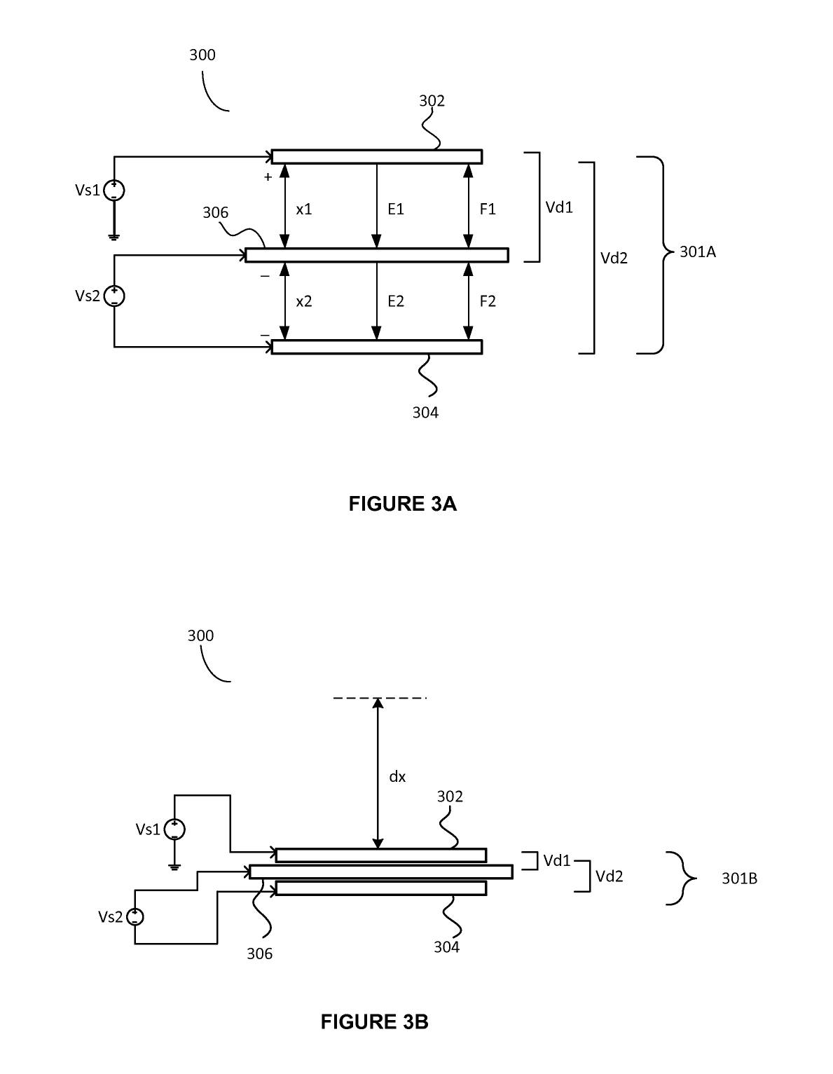

FIGS. 3A and 3B show an example actuator 300 in unactuated (301A) and actuated (301B) states, respectively. The actuator 300 includes a movable outer beam electrode 302, a fixed outer beam electrode 304, and a compliant inner beam electrode 306.

The movable outer beam electrode 302 can be configured to move in a plane substantially parallel to an underlying substrate. In some implementations, the length of the movable outer beam electrode 302 can range from about 20 μm to about 100 μm. In some implementations, the thickness of the movable outer beam electrode 302 can range from about 0.5 μm to about 2 μm. In some implementations, the height of the movable outer beam electrode 302 can range from about 2 μm to about 10 μm. The movable outer beam electrode 302 may be formed from or include one or more materials that facilitate operation of the actuator 300. Candidate materials can include, without limitation, metals such as aluminum (Al), copper (Cu), nickel (Nil, chromium (Cr), molybdenum (Mo), titanium (Ti), tantalum (TO, niobium (Nb), neodymium (Nd), or alloys thereof; dielectric materials such as aluminum oxide (Al₇O₃), silicon oxide (SiO₂), tantalum pentoxide (Ta₂O₅), or silicon nitride (Si₃N₄); or semiconducting materials such as diamond-like carbon, silicon (Si), germanium (Ge), gallium arsenide (GaAs), cadmium telluride (CdTe) or alloys thereof. At least one of the layers, such as the conductor layer, should be electrically conducting so as to carry charge on to and off of the actuation elements. Candidate materials include, without limitation, Al, Cu, Ni, Cr, Mo, Ti, Ta, Nb, Nd, or alloys thereof or semiconducting materials such as diamond-like carbon, Si, Ge, GaAs, CdTe or alloys thereof. In some implementations employing semiconductor layers, the semiconductors are doped with impurities such as phosphorus (P), arsenic (As), boron (B) or Al.

In some implementations, the movable outer beam electrode 302 may serve as a load beam electrode that is coupled to a movable light blocking component, such as a shutter. In some implementations, the movable outer beam electrode 302 has a reduced degree of mechanical compliance as compared to the compliant inner beam electrode 306.

The fixed outer beam electrode 304 is a substantially rigid, non-compliant beam electrode that is configured to remain in a fixed position during actuation. In some implementations, the length of the fixed outer beam electrode 304 can range from about 20 am to about 150 μm. In some implementations, the thickness of the fixed outer beam electrode 304 can range from about 2 μm to about 4 pin in some implementations, the height of the fixed outer beam electrode 304 can range from about 2 μm to about 10 μm. The fixed outer beam electrode 304 can include one or more materials identified above as being suitable for use in the movable outer beam electrode 302. In some implementations, the fixed outer beam electrode 304 is coupled at one or both ends to anchor(s) that are fixed to an underlying substrate.

The compliant inner beam electrode 306 is a compliant beam electrode that is configured to move in a plane substantially parallel to an underlying substrate. In some implementations, the length of the compliant inner beam electrode 306 can range from about 20 μm to about 150 μm. In some implementations, the thickness of the compliant inner beam electrode 306 can range from about 0.5 μm to about 1 μm. In some implementations, the height of the compliant inner beam electrode 306 can range from about 2 μm to about 10 μm. The compliant inner beam electrode 306 can include one or more of the materials identified as being suitable for use in the movable outer beam electrode 302. In some implementations, the compliant inner beam electrode 306 is formed from fewer layers of materials to decrease its thickness and increase its compliance relative to the movable outer beam electrode 302 and the fixed outer beam electrode 304. In some implementations, one or more materials are selected to form the compliant inner beam electrode 306 based on the material's increased mechanical compliance relative to the material used to form the movable outer beam electrode 302 and the fixed outer beam electrode 304. In some implementations, the compliant inner beam electrode 306 is formed to include bends, such as corrugations, to increase compliance.

In some implementations, the compliant inner beam electrode 306 has a greater degree of mechanical compliance relative to the fixed outer beam electrode 304. In some implementations, the compliant inner beam electrode 306 also has a greater degree of mechanical compliance than both of the movable outer beam electrode 302 and the fixed outer beam electrode 304.

In some implementations, the movable outer beam electrode 302 is configured to receive a first voltage from voltage source Vs1. The compliant inner beam electrode 306 and the fixed outer beam electrode 304 are configured to receive a second voltage from voltage source Vs2. The first voltage Vs1 can range from about −25V to about 25V. The second voltage Vs2 can range from about −25V to about 25V. In some implementations, the first voltage is sufficiently different from the second voltage to generate an electric field E1 and electrostatic force F1 between the movable outer beam electrode 302 and the compliant inner beam electrode 306 that is strong enough to draw the movable outer beam electrode 302 and the compliant inner beam electrode 306 together. The first voltage is generates an additional electric field E2 and electrostatic force F2 between the movable outer beam electrode 302 and the fixed outer beam electrode 304. As the movable outer beam electrode 302 moves closer to the compliant inner beam electrode 306 and the fixed outer beam electrode, the electrostatic forces F1 and F2 increases.

As illustrated by Equation 1 below, the electrostatic forces F1 and F2 are proportional to the square of the applied voltage, and inversely proportional to the square of the distance. As further illustrated by Equation 1, reducing both the applied voltage and the distance by half can result in approximately the same electrostatic force.

### Equation 1:

$$F ∼ \frac{( {V}^{2} )}{( {d}^{2} )} ∼ \frac{{( \frac{V}{2} )}^{2}}{{( \frac{d}{2} )}^{2}}$$

In Equation 1, F is the resulting electrostatic force between two beam electrodes, V is the applied voltage difference between the two beam electrodes, and d is the separation distance between the two beam electrodes.

As shown by Equation 1, a reduction in the distance between beam electrodes by one-half along with a concurrent one-half reduction in voltage can result in an approximately equal level of force. In an illustrative example actuator, a movable outer beam electrode and a fixed outer beam electrode can be separated by a separation distance of about 30 μm. In this example, to achieve a desired actuation electrostatic force F1, a voltage of V1 can be applied to the movable outer beam electrode, and the fixed outer beam electrode can be grounded. As shown in FIG. 3A, by including a compliant inner beam electrode 306 approximately halfway between the movable outer beam electrode 302 (e.g., x1) and the fixed outer beam electrode 304 (e.g., x2), the separation distance between adjacent beams will be approximately 15 μm (without accounting for the thickness of the compliant inner beam electrode 306).

As shown in Equation 2 below, the resulting reduction in distance by one-half allows the actuator 300 to achieve the same desired actuation force of F1 by applying approximately half the voltage V1 to the movable outer beam electrode 302.

### Equation 2:

$$F ∼ \frac{{V}^{2}}{{( 30 µm )}^{2}} ∼ \frac{{( \frac{V}{2} )}^{2}}{{( \frac{30 µm}{2} )}^{2}} ∼ \frac{{( \frac{V}{2} )}^{2}}{{( 15 µm )}^{2}}$$

Therefore, with the inclusion of the compliant inner beam electrode 306 positioned about halfway between at least a portion of the movable outer beam electrode 302 and at least a portion of the fixed outer beam electrode 304, the actuator 300 can provide equivalent actuation with about half the applied actuation voltage.

In the unactuated state 301A, the movable outer beam electrode 302 of the actuator 300 is separated from the compliant inner beam electrode 306 by a separation distance of x1, and the fixed outer beam electrode 304 is separated from the compliant inner beam electrode 306 by a separation distance of x2. The separation distances x1 and x2 can range from about 10 μm to about 25 μm. The separation distances x1 and x2, can be any distance that allows the generation of sufficient electrostatic forces F1 and F2, respectively, to actuate the actuator 300 at a desired rate and within a desired operating voltage range. In some implementations, the distances x1 and x2 are substantially similar such that the compliant inner beam electrode 306 is approximately halfway between the movable outer beam electrode 302, and the fixed outer beam electrode 304 in the unactuated state 301A.

During actuation, the voltage source Vs1 applies the first voltage to the movable outer beam electrode 302. In some implementations, the voltage source Vs1 applies an actuation voltage, while in other implementations the voltage source Vs1 applies a bias voltage such as ground or other low magnitude voltage, up to, for example, about ±3V. Further, during actuation, the voltage source Vs2 applies the second voltage to the compliant inner beam electrode 306 and the fixed outer beam electrode 304. In some implementations, the voltage source Vs2 applies an actuation voltage, while in other implementations the voltage source Vs2 applies a bias voltage, such as ground or other low magnitude voltage up to, for example, +3V. In some implementations, the actuation voltage can range from about ±10 V to about ±25 V.

FIG. 3B shows the actuator 300 in an actuated state 30B (e.g., partially or fully closed) as a result of the application of an actuation voltage. During actuation, the application of the first voltage to the movable outer beam electrode 302 and the second voltage to the compliant inner beam electrode 306 draws the movable outer beam electrode 302 together with the compliant inner beam electrode 306. The movable outer beam electrode 302 is configured to move towards the compliant inner beam electrode 306. As the movable outer beam electrode 302 and the compliant inner beam electrode 306 are drawn together, the second voltage applied to the fixed outer beam electrode 304 also draws the movable outer beam electrode 302 towards the fixed outer beam electrode 304. As the movable outer beam electrode 302 moves closer to the fixed outer beam electrode 304, the electrostatic force F2 between the fixed outer beam electrode 304 and the movable outer beam electrode 302 increases, which eventually results in full actuation 301B of the actuator 300.

In some implementations, the actuator 300 can be configured to control the state of a light modulator. For example, the actuator 300 can include components such as anchors, springs, and shutters to facilitate light modulation. For example, one or more anchors may support the movable outer beam electrode 302, fixed outer beam electrode 304 and compliant inner beam electrode 306 over the underlying substrate mentioned above. For example, the compliant inner beam electrode 306 may be coupled via springs to an anchor such that, during actuation, the compliant inner beam electrode 306 can move towards both the movable outer beam electrode 302 as well as the fixed outer beam electrode 304. However, when the actuation voltage is removed, the spring may cause the compliant beam electrode 306 to return to the unactuated state 301A shown in FIG. 3A. Similarly, the movable outer beam electrode 302 may be coupled to an anchor via a spring, or the movable outer beam electrode 302 may be coupled to a shutter (e.g., a movable light blocking component) that is itself coupled to an anchor via a spring. In some implementations, the voltages applied to the movable outer beam electrode 302, fixed outer beam electrode 304 and/or the compliant inner beam electrode 306 are provided via such anchors.

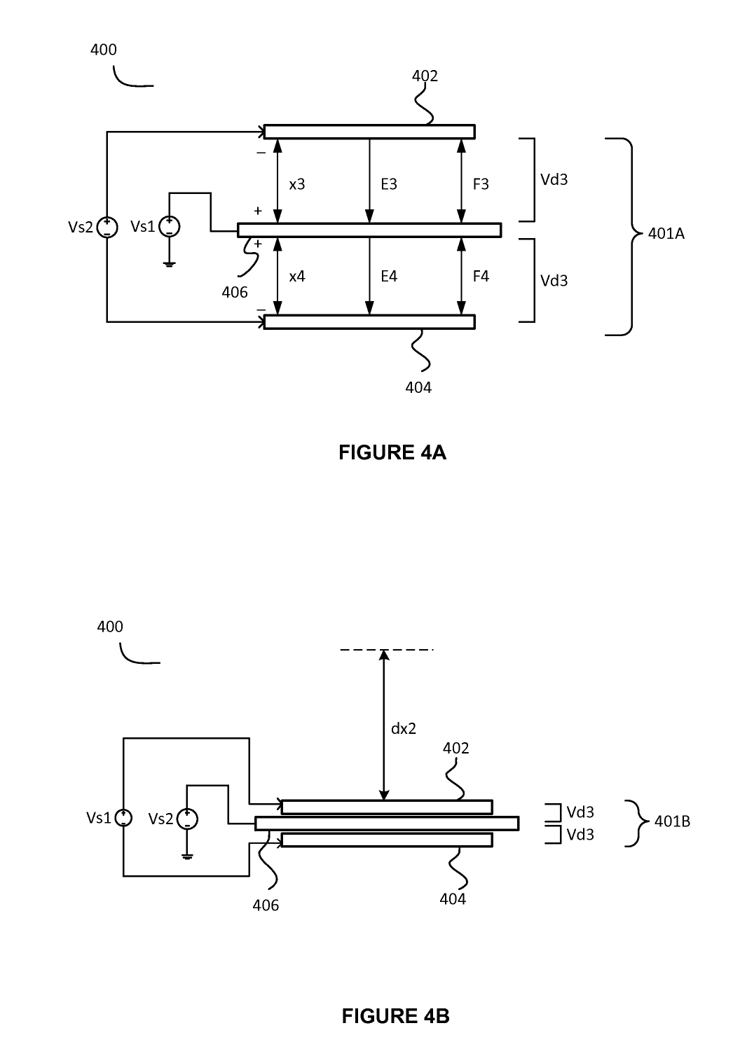

FIGS. 4A and 4B show an example actuator 400 in unactuated (401A) and actuated (401B) states, respectively. The actuator 400 in the unactuated state 401A includes a movable outer beam electrode 402, a fixed outer beam electrode 404 and a compliant inner beam electrode 406 at least partially positioned between the movable outer beam electrode 402 and the fixed outer beam electrode 404. In the unactuated state (401A), the movable outer beam electrode 402 is separated from the compliant inner beam electrode 406 by a distance of x3, and the compliant inner beam electrode 406 is separated from the fixed outer beam electrode 404 by a distance of x4. The separation distances x3 and x4 can range from about 10 μm to about 25 μm. The separation distances x3 and x4 can be any distance that allows the generation of sufficient electrostatic forces F3 and F4, respectively, to actuate the actuator 400 at a desired rate and within a desired operating voltage range.

Structurally, the actuator 400 can be substantially identical to the actuator 300 shown in FIGS. 3A and 3B. However, while the compliant inner beam electrode 306 and fixed outer beam electrode 304 of the actuator 300 shown in FIGS. 3A and 3B were coupled to a common voltage source Vs2, in the actuator 400, the movable outer beam electrode 402 and the fixed outer beam electrode 404 are coupled to a common voltage source Vs2, and the compliant inner beam electrode 406 is coupled to a separate voltage source Vs1. That is, the compliant inner beam electrode 406 is configured to receive a sufficiently different second voltage from a voltage source Vs1 to cause the movable outer beam electrode 402, fixed outer beam electrode 404, and compliant inner beam electrode 406 to be drawn together into contact with one another.

In some implementations, the voltage source Vs2 applies a bias voltage, such as a ground or other low magnitude voltage up to, for example, +3V, while in other implementations the voltage source Vs2 applies an actuation voltage. In some implementations, the voltage source Vs1, applies the actuation voltage, while in other implementations the voltage source Vs1 applies a bias voltage or other low magnitude voltage up to, for example, +3V. As with the actuator 300 shown in FIGS. 3A and 3B, in some implementations, the actuation voltage can range from about ±10 V to about ±25 V and the bias voltage can range from about 0 V to about ±5 V.

During actuation of the actuator 400 shown in FIG. 4A, an electrostatic force F3 draws the movable outer beam electrode 402 and the compliant inner beam electrode 406 together, and an electrostatic force E1 draws the compliant inner beam electrode 406 and the fixed outer beam electrode 404 together. For example, the compliant inner beam electrode 406 is configured to receive an actuation voltage from voltage source Vs1 and the movable outer beam electrode 402 and the fixed outer beam electrode 404 are configured to receive a voltage from the voltage source Vs2 that is substantially different from the actuation voltage being applied to the compliant inner beam electrode 406. The first and second voltages can be selected to be any voltages sufficient to create a sufficient voltage difference Vd3 between the movable outer beam electrode 402, and the compliant inner beam electrode 406, as well as the fixed outer beam electrode 404 and the compliant inner beam electrode 406 to draw the movable outer beam electrode 402, compliant inner beam electrode 406, and fixed outer beam electrode 404 into contact at a desired rate. The voltage Vd3 generates an electric field E3 between the movable outer beam electrode 402 and the compliant inner beam electrode 406, and an electric field E4 between the compliant inner beam electrode 406 and the fixed outer beam electrode 404. The electric fields E3 and E4 generate corresponding electrostatic forces F3 and F4, which draw the movable outer beam electrode 402 towards the compliant inner beam electrode 406, and the compliant inner beam electrode 406 towards the fixed outer beam electrode 404.

In some implementations, the movable outer beam electrode 402 and the compliant inner beam electrode 406 are configured to move and/or deform during actuation, and the fixed outer beam electrode 404 is configured to remain fixed during actuation. In some implementations, the movable outer beam electrode 402 has a lesser degree of stiffness relative to the fixed outer beam electrode 404. In some implementations, the stiffness of the movable outer beam electrode 402 ranges from about 0.5 N/m to about 3 N/m. In some implementations, the stiffness of the movable outer beam electrode 402 ranges from about ¼ to about ¾ the stiffness of the fixed outer beam electrode 404. In some implementations, the movable outer beam electrode 402 is just as rigid and non-compliant as the fixed outer beam electrode 404. In some implementations, the compliant inner beam electrode 406 has a greater degree of mechanical compliance relative to one or both of the movable outer beam electrode 402 and the fixed outer beam electrode 404. Therefore, during actuation, the movable outer beam electrode 402 moves toward the compliant inner beam electrode 406, and the compliant inner beam electrode 406 moves toward the fixed outer beam electrode 404. This can result in partial or full actuation of actuator 400, as shown in the actuated state 401B of FIG. 4B. The movable outer beam electrode 402 can move a distance of dx2, which may be the sum of distances x3 and x4. In some implementations, where the actuator 400 is partially actuated, the distance dx2 may be less than the sum of x3 and x4.

Similar to the electrostatic forces described above in relation to actuator 300 of FIGS. 3A and 3B, the electrostatic forces F3 and F4 shown in FIG. 4A are proportional to the square of the applied voltage, and inversely proportional to the square of the distance. Therefore, a reduction in the distance between beam electrodes by one-half along with a concurrent one-half reduction in voltage can result in an approximately equal level of three. In an illustrative example actuator, a movable outer beam electrode and a fixed outer beam electrode can be separated by a separation distance of about 30 μm. In this example, to achieve a desired actuation electrostatic force F3, a voltage of V1 can be applied to the movable outer beam electrode, and the fixed outer beam electrode can be grounded, However, and as shown in FIG. 4A, by including a compliant inner beam electrode 406 approximately halfway between the movable outer beam electrode 402 (e.g., x3) and the fixed outer beam electrode 404 (e.g., x4), the separation distance between adjacent beams will be approximately 15 μm (without accounting for the thickness of the compliant inner beam electrode 406). As shown by Equation 2 above, the resulting one-half reduction in distance allows the actuator 400 to achieve the same desired actuation force of F3 by applying approximately half the voltage V1 to the compliant inner beam electrode 406, while grounding both the movable outer beam electrode 402 and the fixed outer beam electrode 404. Therefore, with the inclusion of the compliant inner beam electrode 406 positioned about halfway between at least a portion of the movable outer beam electrode 402 and at least a portion of the fixed outer beam electrode 404, the actuator 400 can provide actuation with about half the actuation voltage.

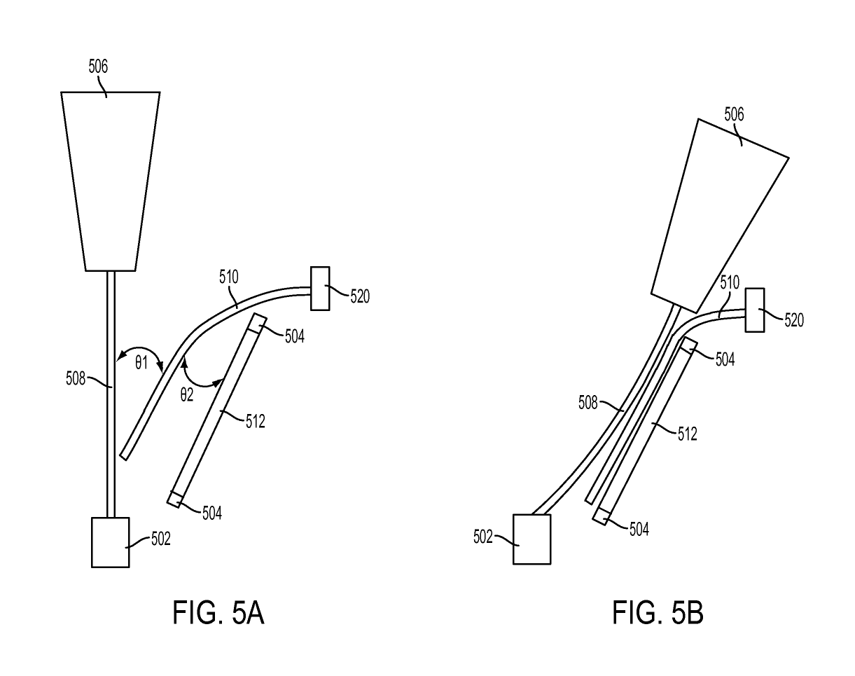

FIGS. 5A and 5B show an example light modulator 500 in unactuated (501A) and actuated (501B) states, respectively. The light modulator 500 includes a shutter 506 coupled to a movable outer beam electrode 508 that is further coupled to an anchor 502. The anchor 502 and the movable outer beam electrode 508 are configured to allow the shutter 506 to move radially about an axis through the anchor 502. The light modulator 500 also includes a fixed outer beam electrode 512 coupled to anchors 504 at either end, and a compliant inner beam electrode 510 that is positioned between the movable outer beam electrode 508 and the fixed outer beam electrode 512. The compliant inner beam electrode 510, which is coupled to an anchor 520, is configured to have sufficient mechanical compliance to bend or be pulled towards the fixed outer beam electrode 512 or towards the movable outer beam electrode 508. While in the unactuated state 501A, the movable outer beam electrode 508 and the compliant inner beam electrode 510 may be separated by a separation angle of θ1, and the fixed outer beam electrode 512 and the compliant inner beam electrode 510 may be separated by a separation angle of θ2.

Still referring to FIG. 5A, and in further detail, the shutter 506 serves as a light blocking component that is configured to move. The shutter 506 may have a length, width and thickness such that the shutter can partially or fully block an aperture through which light passes. In some implementations, the length of the shutter 506 may range from about 50 μm to about 150 μm; the width of the shutter 506 may range from about 25 urn to about 75 μm; and the thickness of the shutter 506 may range from about 0.5 μm to about 2 μm. The shutter 506 may be formed from or include one or more materials described above as being suitable for the movable outer beam electrodes 302 and 402, fixed outer beam electrodes 304 and 404, and compliant inner beam electrodes 306 and 406.

The light modulator 500 includes a movable outer beam electrode 508 that is configured to receive a first voltage. The movable outer beam electrode 508 supports the shutter over an underlying substrate. The movable outer beam electrode 508 is physically coupled to anchor 502 in a manner that allows the first beam electrode to move radially about an axis through the anchor 502, for example through elastic deformation of the movable outer beam electrode 508. In particular, the movable outer beam electrode 508 is configured to deform (or bend) towards the fixed outer beam electrode 512. The movable outer beam electrode 508 may deform about the axis an amount corresponding to the sum of separation angles θ1 and θ2.

The light modulator 500 includes a fixed outer beam electrode 512 that is rigidly coupled at both ends to the anchors 504. The fixed outer beam electrode 512 is configured to receive a second voltage. In some implementations, the fixed outer beam electrode 512 is relatively rigid and non-compliant as compared to the compliant inner beam electrode 510. The length of the fixed outer beam electrode 512 ranges from about 25 μm to about 100 μm; the thickness of the fixed outer beam electrode 512 ranges from about 0.5 μm to about 4 μm; and the height of the fixed outer beam electrode 512 ranges from about 2 μm to about 10 μm. The fixed outer beam electrode 512 may be formed from or include one or more of the materials described above as being suitable for the movable outer beam electrodes 302 and 402, fixed outer beam electrodes 304 and 404, and compliant inner beam electrodes 306 and 406. The anchors 504 are configured to support the fixed outer beam electrode 512 above the same substrate above which the anchor 502 supports the movable outer beam electrode 508. In some implementations, the fixed outer beam electrode 512 receives the second voltage via the anchors 504.

The light modulator 500 includes a compliant inner beam electrode 510 configured to receive a third voltage. The compliant inner beam electrode 510 is coupled to an anchor 520 configured to support the compliant inner beam electrode 510 over an underlying substrate. In some implementations, the anchor 520 can also convey, to the third beam electrode 520 the third voltage provided by a voltage source. The compliant inner beam electrode 510 has a greater degree of mechanical compliance relative to one or both of the movable outer beam electrode 508 and the fixed outer beam electrode 512. The compliant inner beam electrode 510 is configured to deform or flex towards the fixed outer beam electrode 512 and/or the movable outer beam electrode 508. In some implementations, the compliant inner beam electrode 510 is designed and constructed to deform or otherwise be drawn towards the fixed outer beam electrode 512 in response to application of a sufficiently large voltage difference between the compliant inner beam electrode 510 and the fixed outer beam electrode 512.

In some implementations, the length of the compliant inner beam electrode 510 can range from about 20 μm to about 150 μm. In some implementations, the thickness of the compliant inner beam electrode 510 can range from about 0.5 μm to about 1 μm. In some implementations, the height of the compliant inner beam electrode 510 can range from about 2 μm to about 10 μm. The compliant inner beam electrode 510 can include one or more of the materials identified as being suitable for use in the compliant inner beam electrode 306. In some implementations, the compliant inner beam electrode 510 is formed from fewer layers of materials to decrease its thickness and increase its compliance relative to the movable outer beam electrode 508 and the fixed outer beam electrode 512.

In some implementations, similar to those described with respect to FIGS. 3A and 3B, a first voltage source applies a first voltage to the movable outer beam electrode 508, and a second voltage source applies a second voltage to the compliant inner beam electrode 510 and the fixed outer beam electrode 512. In some implementations, similar to those described with respect to FIGS. 4A and 4B, a second voltage source applies a first voltage to the movable outer beam electrode 508 and the fixed outer beam electrode 512, while a third voltage source applies a second voltage to the compliant inner beam electrode 510. In various implementations, the first and second voltages may include actuation voltages or bias voltages.

In some implementations, during actuation of the light modulator 500, the movable outer beam electrode 508 receives a first voltage, the compliant inner beam electrode 510 receives a second voltage and the fixed outer beam electrode 512 receives a third voltage. In some implementations, the first voltage and the second voltage are similar to one another and the third voltage is substantially different from the first voltage and the second voltage. In other implementations, one of the first voltage and the second voltage is similar to the third voltage and the other of the first voltage and the second voltage is substantially different from the third voltage.

In some, implementations, the movable outer beam electrode 508 and the fixed outer beam electrode 512 receive first and second voltages, respectively, that are substantially similar (e.g., a bias voltage such as ground or other low magnitude voltage). For example, the first and second voltages can be applied by a common voltage source. To actuate the light modulator 500, a second voltage source can apply a third voltage to the compliant inner beam electrode 510 that is sufficiently different from the first voltage and the second voltage such that the movable outer beam electrode 508 is drawn toward the compliant inner beam electrode 510, and the compliant inner beam electrode 510 is further drawn toward the fixed outer beam electrode 512. In some implementations, the actuation voltage may range from about ±5 V to about ±25 V.

In some implementations, a common voltage source applies a substantially similar voltage to the compliant inner beam electrode 510 and the fixed outer beam electrode 512 (rather than the movable outer beam electrode 508 and the fixed outer beam electrode 512). A different voltage source then applies a different voltage to the movable outer beam electrode 508, which generates a first electric field between the movable outer beam electrode 508 and the third beam electrode 512. The first electric field generates a first electrostatic force between the movable outer beam electrode 508 and the third beam electrode 512, which draws or deforms the movable outer beam electrode 508 and the third beam electrode 512 together. As the movable outer beam electrode 508 and the compliant inner beam electrode 510 are drawn together, the shutter 506 moves axially about an axis through anchor 502. As the movable outer beam electrode 508 gets closer to the fixed outer beam electrode 512, a second electric field between the movable outer beam electrode 508 and the fixed outer beam electrode 512 strengthens, increasing a second electrostatic force between the movable outer beam electrode 508 and the fixed outer beam electrode 512. This second electrostatic force further draws the movable outer beam electrode 508 towards the fixed outer beam electrode 512. The compliant inner beam electrode 510, which is at least partially positioned between the movable outer beam electrode 508 and the fixed outer beam electrode 512, moves along with the movable outer beam electrode 508 towards the fixed outer beam electrode 512, as shown in the actuated state 501B of the actuator 500 in FIG. 5B.

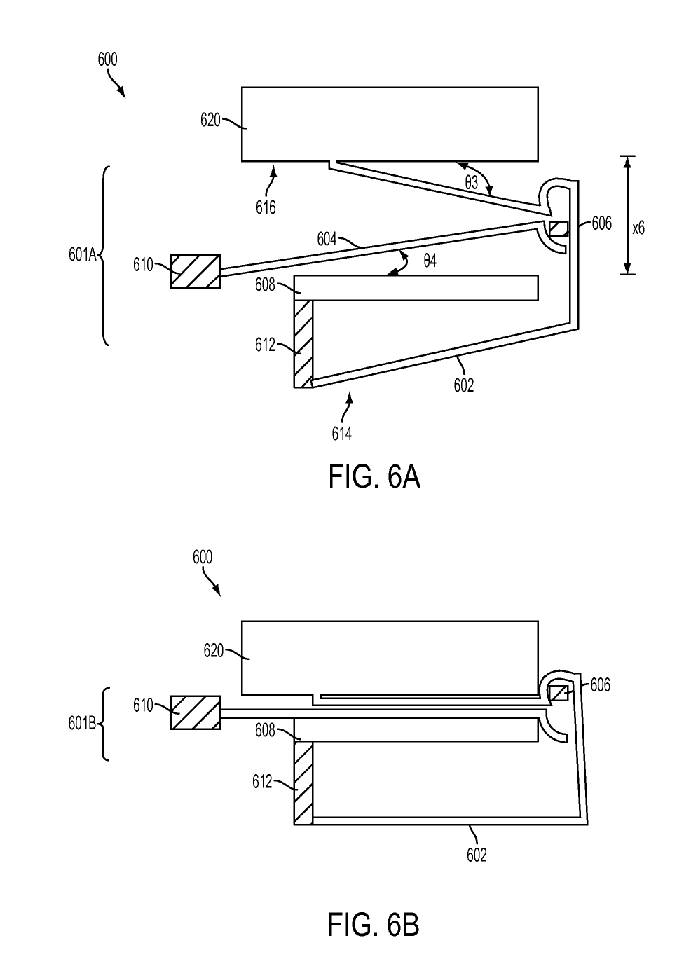

FIGS. 6A and 6B show another example light modulator 600 in unactuated (601A) and actuated (601B) states, respectively. The light modulator 600 includes a shutter 620, a spring beam 602, a fixed beam 608 and a floating beam 604.

A proximal end 616 of the spring beam 602 mechanically couples to the shutter 620, and a distal end 614 of the spring beam 602 couples to an anchor 612 which supports the spring beam 602 over an underlying substrate. The spring beam 602 is configured to support the shutter 620 over the underlying substrate and move the shutter 620 in a plane substantially parallel to the surface.

The floating beam 604 is positioned between the fixed beam 608 and one elongated end of the spring beam 602. The light modulator 600 further includes a mechanical stopper 606 configured to prevent the floating beam 604 from collapsing into a portion of the spring beam 602 proximate to the shutter 620 during actuation. The floating beam 604 is coupled to an anchor 610. The spring beam 602 and floating beam 604 can be configured to receive a first voltage and a second voltage, respectively.

Still referring to FIG. 6A, in some implementations, the spring beam 602 is formed from or includes a material and has dimensions such that it has a sufficient degree of mechanical compliance to allow the proximate end 616 of the spring beam 602 to be drawn together with the floating beam 604 and fixed beam 608. For example, the spring beam 602 can be configured to deform or otherwise bend during actuation of the light modulator 600, and spring back or return to an unactuated state when the actuation voltage is removed. In some implementations, the length of the spring beam 602 can range from about 100 μm to about 300 μm; the thickness of the spring beam 602 can range from about 0.5 μm to about 2.0 μm; and the height of the spring beam 602 can range from about 2 μm to about 10 μm. The spring beam 602 may be formed from or include one or more materials described above as being suitable for the movable outer beam electrodes 302 and 402, fixed outer beam electrodes 304 and 404, and compliant inner beam electrodes 306 and 406.

In some implementations, the floating beam 604 is formed of or includes a material and has dimensions that provide the floating beam 604 with a sufficient degree of mechanical compliance to deform or otherwise bend between the fixed beam 608 and the mechanical stopper 606. In some implementations, the length of the floating beam 604 can range from about 50 μm to about 150 μm; the thickness of the floating beam 604 can range from about 0.5 μm to about 1.0 μm; and the height of the floating beam 604 can range from 2 μm to about 10 μm. The floating beam 604 may be formed from or include one or more materials described above as being suitable for the movable outer beam electrodes 302 and 402, fixed outer beam electrodes 304 and 404, and compliant inner beam electrodes 306 and 406. The floating beam 604 is supported above the underlying substrate by an anchor 610.

The fixed beam 608 mechanically couples to an anchor 612, which supports the fixed beam 608 over the underlying substrate. The length of the fixed beam 608 can range from about 50 μm to about 150 μm. The thickness of the fixed beam 608 can range from about 2 μm to about 4 μm. The height of the fixed beam 608 can range from about 2 μm to about 10 μm. The fixed beam 608 may be formed from or include one or more materials described above as being suitable for the movable outer beam electrodes 302 and 402, fixed outer beam electrodes 304 and 404, and compliant inner beam electrodes 306 and 406.

In some implementations, a common voltage source applies a substantially similar voltage to the spring beam 602 and the fixed beam 608, and a different voltage source applies a significantly different voltage to the floating beam 604. In some implementations, the common voltage source applies substantially similar voltages to the floating beam 604 and the fixed beam 608, and a significantly different voltage to the spring beam 602. The common voltage source and the second voltage source can apply voltages to the spring beam 602, floating beam 604 and fixed beam 608 via their respective anchors 610 and 612.

In some implementations, the common voltage source applies an actuation voltage, while in other implementations the common voltage source applies a bias voltage (e.g., a ground or other low magnitude voltage). In some implementations, a second voltage source applies the actuation voltage, while in other implementations the second voltage source applies the bias voltage. As with the actuator 300 shown in FIGS. 3A and 3B, in some implementations, the actuation voltage can range from about ±10 V to about ±25 V and the bias voltage can range from about 0 V to about ±5 V.

In the unactuated state 601A, the proximal end 616 of the spring beam 602 and the shutter 620 may be separated by a separation angle θ3. The floating beam 604 and the fixed beam 608 may be separated angle θ4. The shutter 620 may be separated from the fixed beam 608 by a separation distance x6.

During actuation of the light modulator 600, in some implementations, the spring beam 602 and the fixed beam 608 receive substantially similar voltages, and the floating beam 604 receives a significantly different voltage. The voltage difference between the proximal end 616 of the spring beam 602 and the floating beam 604 results in an electric field that generates an electrostatic force. This electrostatic force draws the proximal end of the spring beam 602 together with the floating beam 604. In some implementations, where a first portion of the floating beam 604 is closer to the spring beam 602 than a second portion of the floating beam 604, there may be a zipper effect that facilitates progressively drawing the spring beam 602 and floating beam 604 together.

In some implementations, during actuation, the mechanical stopper 606 prevents the floating beam 604 from moving too far towards the spring beam 602. Thus, the spring beam 602 will bend towards the floating beam 604. Since the spring beam 602 is mechanically coupled to the movable shutter 620, the shutter will also move, along with the proximal end 616, towards the floating beam 604.

Further, the voltage difference between the floating beam 604 and the fixed beam 608 will result in an electric field between the floating beam 604 and the fixed beam 608. This resulting electric field generates an additional electrostatic force that deforms or otherwise bends the floating beam 604 towards the fixed beam 608. As shown in FIG. 6B, this results in an actuated state 601B of the light modulator 601.

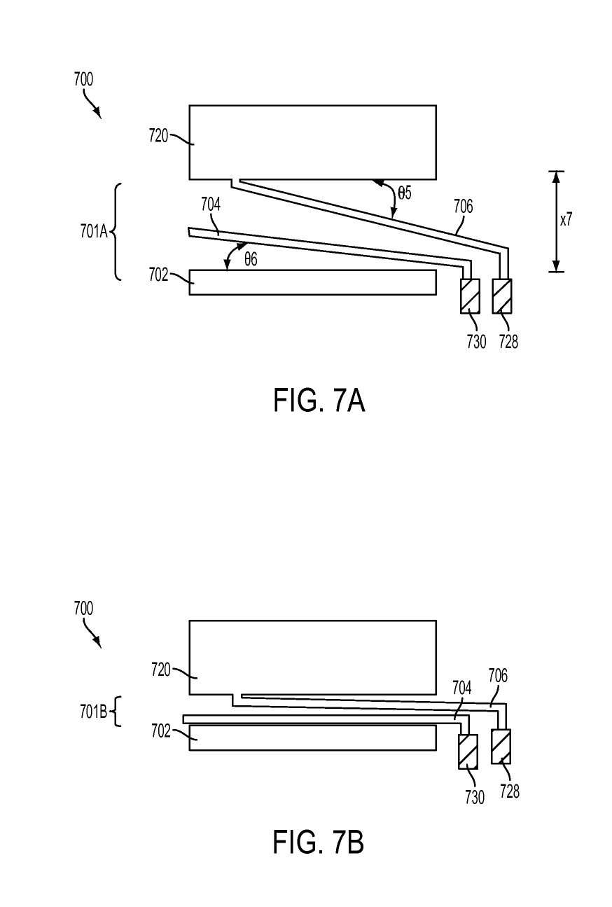

FIGS. 7A and 7B show another example light modulator 700 in unactuated (701A) and actuated (701B) states, respectively. The light modulator 700 includes a shutter 720, a spring beam 706, a floating beam 704 and a fixed beam 702.

The shutter 720 is coupled to the spring beam 706, which is coupled to an anchor 728 that supports the spring beam 706 over an underlying substrate. The spring beam 706 is configured to support the shutter 720 over the underlying substrate and move the shutter 720 in a plane substantially parallel to the underlying substrate. The floating beam 704 is coupled to an anchor 730 that supports the floating beam 704 above the underlying substrate. The floating beam 704 and the spring beam 706 are designed and constructed to be compliant and have a low stiffness such that they can deform or otherwise bend towards the fixed beam 702.

Still referring to FIG. 7A, the spring beam 706 is formed of or includes materials and has dimensions that facilitate supporting the shutter 720 over the underlying substrate, and provide the spring beam 706 with a sufficient degree of mechanical compliance to deform or otherwise bend to draw the shutter 720 towards the fixed beam 702. In some implementations, the length of the spring beam 706 can range from about 50 μm to about 150 μm; the thickness of the spring beam 706 can range from about 0.5 μm to about 2.0 μm; and the height of the spring beam 706 can range from about 2 μm to about 10 μm. The spring beam 706 may be formed from or include one or more materials described above as being suitable for the movable outer beam electrodes 302 and 402, fixed outer beam electrodes 304 and 404, and compliant inner beam electrodes 306 and 406.

The fixed beam 702 is formed of or includes materials and has dimensions that cause the fixed beam 702 to be substantially rigid such that it does not move responsive to the application of an actuation voltage. The fixed beam 702 may be substantially rigidly fixed to an underlying substrate. In some implementations, the fixed beam 702 may be coupled to an anchor, while in other implementations the fixed beam 702 may have properties of anchor. In some implementations, the length of the fixed beam 702 can range from about 50 μm to about 150 μm. The thickness of the fixed beam 702 can range from about 2 μm to about 4 μm. The height of the fixed beam 702 can range from about 2 μm to about 10 μm. The fixed beam 702 may be formed from or include one or more materials described above as being suitable for the movable outer beam electrodes 302 and 402, fixed outer beam electrodes 304 and 404, and compliant inner beam electrodes 306 and 406.

The floating beam 704 mechanically couples at one end to an anchor 704 which supports it over the underlying substrate. The floating beam 704 is formed of or includes materials and has dimensions that provide it with a sufficient degree of mechanical compliance to deform or bend between the fixed beam 702 and the spring beam 706. For example, the floating beam 704 may have a greater degree of mechanical compliance than the fixed beam 702 and the spring beam 706.

In some implementations, the length of the floating beam 704 can range from about 50 μm to about 150 μm; the thickness of the floating beam 604 can range from about 0.5 μm to about 1.0 μm; and the height of the floating beam 704 can range from 2 μm to about 10 μm. The floating beam 704 may be formed from or include one or more materials described above as being suitable for the movable outer beam electrodes 302 and 402, fixed outer beam electrodes 304 and 404, and compliant inner beam electrodes 306 and 406.

As with the actuator 600 shown in FIGS. 6A and 6B, in some implementations, a common voltage source applies a substantially similar voltage to the spring beam 706 and the fixed beam 702, and a second voltage source applies a significantly different voltage to the floating beam 704. In some implementations, the common voltage source applies the substantially similar voltages to the floating beam 704 and the fixed beam 702, and the significantly different voltage is applied to the spring beam 706. The common voltage source and the second voltage source can apply voltages to the spring beam 706, floating beam 704 and fixed beam 702 via their respective anchors 610 and 612.

In some implementations, the common voltage source applies an actuation voltage, while in other implementations the common voltage source applies a bias voltage (e.g., a ground or other low magnitude voltage). In some implementations, the second voltage source applies the actuation voltage, while in other implementations the second voltage source applies the bias voltage. As with the actuator 300 shown in FIGS. 3A and 3B, in some implementations, the actuation voltage can range from about ±10 V to about ±25V and the bias voltage can range from about 0 V to about ±5 V.

In the unactuated state 701A, the spring beam 706 is separated from the shutter by a separation angle θ5, and the floating beam 704 is separated from the fixed beam 702 by a separation angle θ6. The shutter 720 may be separated from the fixed beam 702 by a separation distance x7.

As indicated above, in some implementations, during actuation, the common voltage source applies a substantially similar voltage to the spring beam 706 and the fixed beam 702, and a different voltage source applies a significantly different voltage to the floating beam 704. The resulting voltage difference between the spring beam 706 and the floating beam 704 generates an electric field, which generates an electrostatic force sufficient to draw the spring beam 706 and the floating beam 704 together. Also during actuation, a voltage difference between the floating beam 704 and the fixed beam 702 generates a second electric field, which generates an additional electrostatic force sufficient to draw the floating beam 704 together with the fixed beam 702. Since the spring beam 706 and the mechanically coupled shutter 720 are being drawn together with the floating beam 704, they will also be drawn together with the fixed beam 702 by the floating beam 704, resulting in the actuated state 701B shown in FIG. 7B.

In some implementations, applying the substantially similar voltage to the fixed beam 702 and the floating beam 704, and the significantly different voltage to the spring beam 706, can also result in the actuated state 701B. For example, a resulting voltage difference between the spring beam 706 and the floating beam 704 generates an electrostatic force between the spring beam 706 and the floating beam 704. As the spring beam 706 bends or otherwise deforms together with the floating beam 704, the spring beam 706 moves closer to the fixed beam 702. As the spring beam 706 moves closer towards the fixed beam 702, the electric field between the spring beam 706 and the fixed beam 702 strengthens, thus increasing the electrostatic force between the spring beam 706 and the fixed beam 702. This increase in electrostatic force further deforms or otherwise bends the spring beam 706 together with the fixed beam 702.

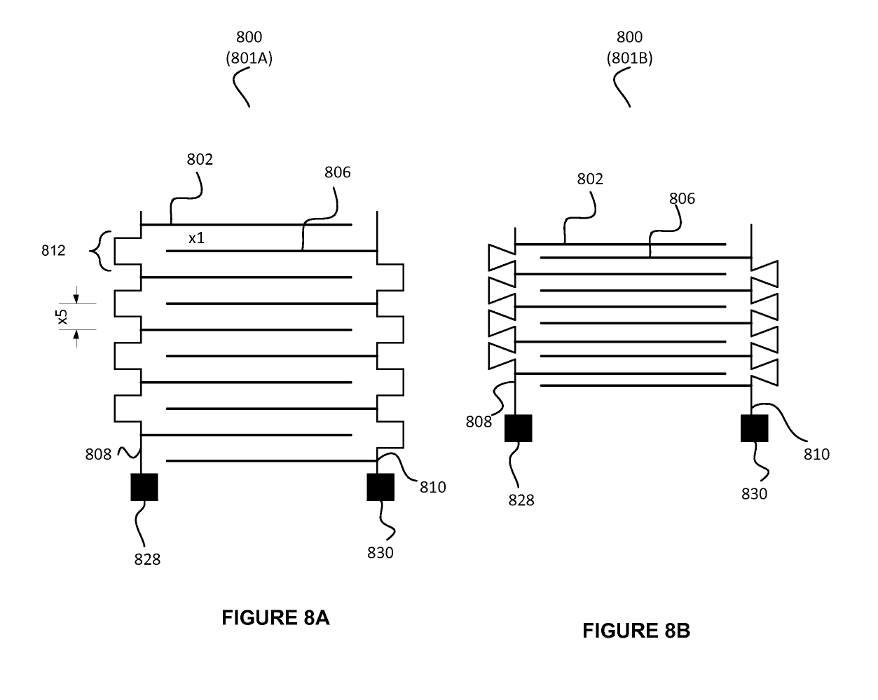

FIGS. 8A and 8B show an example distributed electrostatic actuator 800 in unactuated (801A) and actuated (801B) states, respectively. The actuator 800 includes a first compressible wall 808 and a second compressible wall 810. Coupled to the first compressible wall 808 are two or more first wall beam electrodes 802. Similarly, two or more second wall beam electrodes 806 are coupled to the second compressible wall 810. The first wall beam electrodes 802 and the second wall beam electrodes 806 are positioned such that they alternate. That is, each first wall beam electrode 802 is adjacent to a second wall beam electrode 806. In some implementations, the actuator 800 includes a compressible but resilient material 804 between the beam electrodes 802 and 806. The actuator 800 includes a first anchor 828 coupled to the first compressible wall 808. The actuator 800 includes a second anchor 830 coupled to the second compressible wall 810.

As indicated above, the actuator 800 includes a first compressible wall 808. The first compressible wall 808 includes one or more rectangular portions 812 that are configured to compress, as shown in FIG. 8B. Each rectangular portion 812 includes two parallel sides and a perpendicular side. The perpendicular side is coupled to an end of each of the parallel sides. The opposite ends of the parallel sides are free to move relative to the fixed end. During actuation, the free ends of the parallel sides can move towards each other, while the fixed ends remain separated by the same distance, as shown in FIG. 8B.

The first compressible wall 808 may be formed from or include one or more materials described above as being suitable for the movable outer beam electrodes 302 and 402, fixed outer beam electrodes 304 and 404, and compliant inner beam electrodes 306 and 406. The first compressible wall 808 can include dimensions that facilitate actuation or compression of the actuator 800. For example, the first compressible wall 808 can include an overall length based, at least in part, on the number of rectangular portions 812. In some implementations, the overall length can range from about 30 μm to about 100 μm. The first compressible wall 800 can include a thickness ranging from about 1 μm to about 5 μm. A height of the first compressible wall 800 ranges from about 3 μm to about 10 μm.

The actuator 800 includes a second compressible wall 810 similar to the first compressible wall 808. The first and second compressible walls 808 and 810, respectively, are positioned such that they are substantially parallel to one another. In some implementations, the first and second compressible walls are mirror images of one another. In other implementations, one or more dimensions of the first compressible wall 808 vary from the second compressible wall 810.

As set forth above, the actuator 800 includes two or more first wall beam electrodes 802 coupled to the first compressible wall, and two or more second wall beam electrodes 806 coupled to the second compressible wall 810. The first wall and second wall beam electrodes 802 and 806 can have a length ranging from about 3 urn to about 25 μm; a height ranging from about 3 μm to about 10 μm; and a thickness ranging from about 0.5 μm to about 3 μm.

A first voltage source can apply a first voltage to the first wall beam electrodes 802, and a second voltage source can apply a second voltage to the second wall beam electrodes 806. For example, the first and second voltage sources can apply the first and second voltages to the first and second wall beam electrodes 802 and 806 via the first anchor 828 and the second anchor 830, respectively. The first and second voltages are substantially different from one another to generate an electrostatic force between the first and second wall beam electrodes 802 and 806 sufficient to draw the first and second wall beam electrodes 802 and 806 together. In some implementations, the first voltage source may apply an actuation voltage, while the second voltage source applies a bias voltage such as ground or other low magnitude voltage. In some implementations, the actuation voltage can range from about ±10 V to about ±25 V, and the bias voltage can range from about 0 V to about ±5 V.

When the actuator 800 is in an open or unactuated state 801A, the first wall and second wall beam electrodes 802 and 806 are separated from one another by a distance x5. During actuation, the first wall beam electrodes 802 are configured to receive a first voltage, while the beam electrodes 806 are configured to receive a second voltage. The difference between the first voltage and the second voltage creates an electric field between each pair of beam electrodes 802 and 806. This electric field generates an electrostatic force that draws the first wall and second wall beam electrodes 802 and 806 together. As a first wall beam electrode 802 is drawn towards a first second wall beam electrode 806, the first second wall beam electrode 806 is drawn towards a second first wall beam electrode 802, and the second first wall beam electrode 802 is drawn towards a second wall beam electrode 806, and so on, depending on the number of first and second wall beam electrode 802 and 806 the actuator 800 includes. The actuated actuator 801 is shown in FIG. 8B.

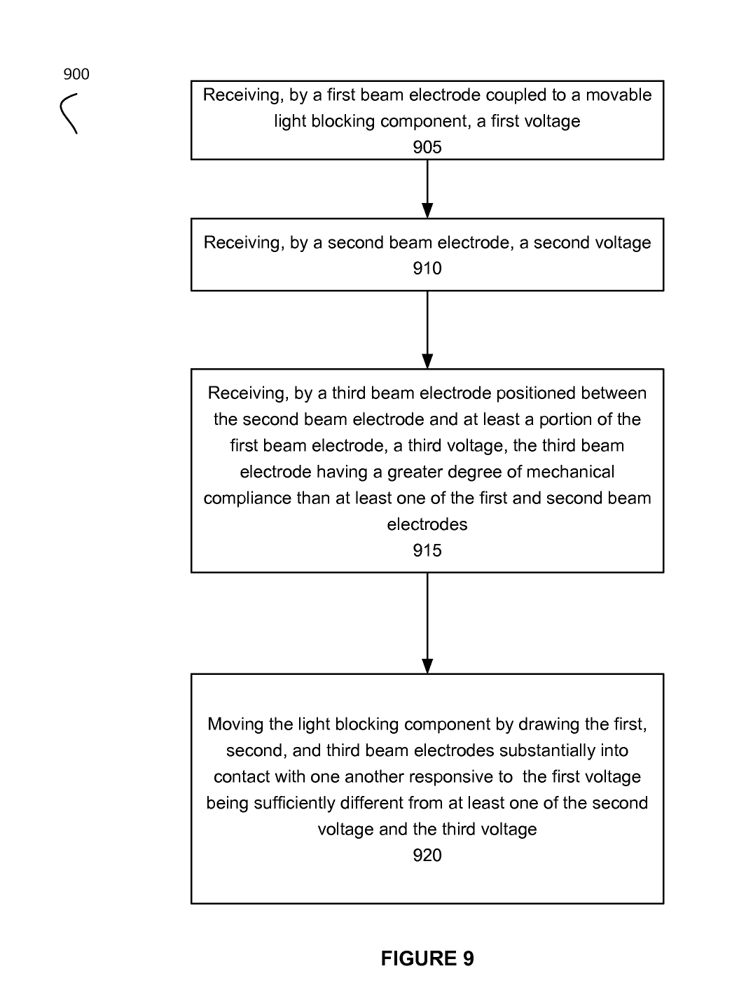

FIG. 9 shows a flow diagram of an example method 900 of actuating a distributed electrostatic actuator. The method 900 includes a first beam electrode receiving a first voltage (stage 905). The first beam electrode is coupled to a movable light blocking component. The method 900 includes a second beam electrode receiving a second voltage (stage 910). The method 900 includes a third beam electrode positioned between the first beam electrode and the second beam electrode receiving a third voltage (stage 915). The method 900 includes drawing the first, second, and third beam electrodes substantially into contact with one another to move the light blocking component (stage 920).

Still referring to FIG. 9, the method 900 includes a first beam electrode receiving a first voltage (stage 905). In some implementations, the first beam electrode receives the first voltage responsive to an actuation of the actuator. The first voltage can include an actuation voltage provided by a voltage source. In some implementations, the first voltage includes a bias voltage such as ground or other low magnitude voltage. In some implementations, the first beam electrode serves as a movable outer beam electrode similar to the movable outer beam electrodes 302, 402, 508, 602, and 706 shown in FIGS. 3A-7B. In some implementations, the first beam electrode receives the first voltage for a duration of time. The duration of time may correspond to the amount of time it takes the actuator to partially or fully actuate plus the desired duration of actuation.

The method 900 includes a second beam electrode receiving a second voltage (stage 910). In some implementations, the second beam electrode is similar to the fixed outer beam electrodes 304, 404, 512, 608, and 702 shown in FIGS. 3A-7B. For example, the second beam electrode may be fixedly anchored to an underlying substrate. In some implementations, the second beam electrode receives the second voltage responsive to an actuation of the actuator. In some implementations, the second voltage is similar to the first voltage. For example, the first and second voltage may be provided by a single voltage source. In some implementations, the second voltage is significantly different from the first voltage. For example, the first voltage may include a positive actuation voltage, and the second voltage may include a negative voltage, or a bias voltage such as ground.

The method 900 includes a third beam electrode positioned between the first beam electrode and the second beam electrode receiving a third voltage (stage 915). In some implementations, the third beam electrode is similar to the compliant inner beam electrodes 306, 406, 510, 604, and 704 shown in FIGS. 3A-7B. In some implementations, the third voltage is significantly different from the first voltage and the second voltage. In some implementations, the third voltage is significantly different from only one of the first voltage and the second voltage. That is, the third voltage is substantially the same as one of the first voltage or the second voltage.

In some implementations, the third beam electrode is positioned between the second beam electrode and at least a portion of the first beam electrode. In some implementations, in an unactuated state, the third beam electrode is spaced an equal distance from the first beam electrode and the second beam electrode. That is, the third beam electrode is positioned halfway between the first beam electrode and the second beam electrode. In some implementations, the third beam electrode has a greater degree of mechanical compliance than at least one of the first beam electrode and the second beam electrode. In some implementations, the third beam electrode has a greater degree of mechanical compliance than both the first beam electrode and the second beam electrode.

The method 900 includes drawing the first, second, and third beam electrodes substantially into contact with one another to move the light blocking component (stage 920). The first, second and third beam electrodes are drawn together responsive to the first voltage being significantly different from at least one of the second voltage and the third voltage. For example, applying the significantly different voltage to the compliant inner beam electrode can draw the movable outer beam electrode, compliant inner beam electrode and fixed outer beam electrode together. That is, the movable outer beam electrode will be drawn towards the compliant inner beam electrode due to an electrostatic force between the movable outer beam electrode and the compliant beam electrode. At the same time, the compliant inner beam electrode will be drawn towards the fixed outer beam electrode. Thus, as the movable outer beam electrode is drawn toward the compliant inner beam electrode, the combined movable outer beam electrode and compliant inner beam electrode will move towards the fixed outer beam electrode.

In another example, applying the significantly different voltage to the movable outer beam electrode draws the movable outer beam electrode, compliant inner beam electrode, and fixed outer beam electrode together. For example, the significantly different voltage between the movable outer beam electrode and compliant inner beam electrode results in an electric field between the movable outer beam electrode and compliant inner beam electrode that generates an electrostatic force. This electrostatic force causes the movable outer beam electrode to move towards the compliant beam electrode. As the movable outer beam electrode moves towards the compliant beam electrode, the movable outer beam electrode also gets closer to the fixed outer beam electrode. As the movable outer beam electrode moves closer to the fixed outer beam electrode, the electrostatic force between the movable outer beam electrode and the fixed outer beam electrode increases, thus further drawing the movable outer beam electrode toward the fixed outer beam electrode. Because the compliant inner beam electrode is positioned between the movable outer beam electrode and the fixed outer beam electrode, the movable outer beam electrode will also move the compliant inner beam electrode towards the fixed beam electrode.

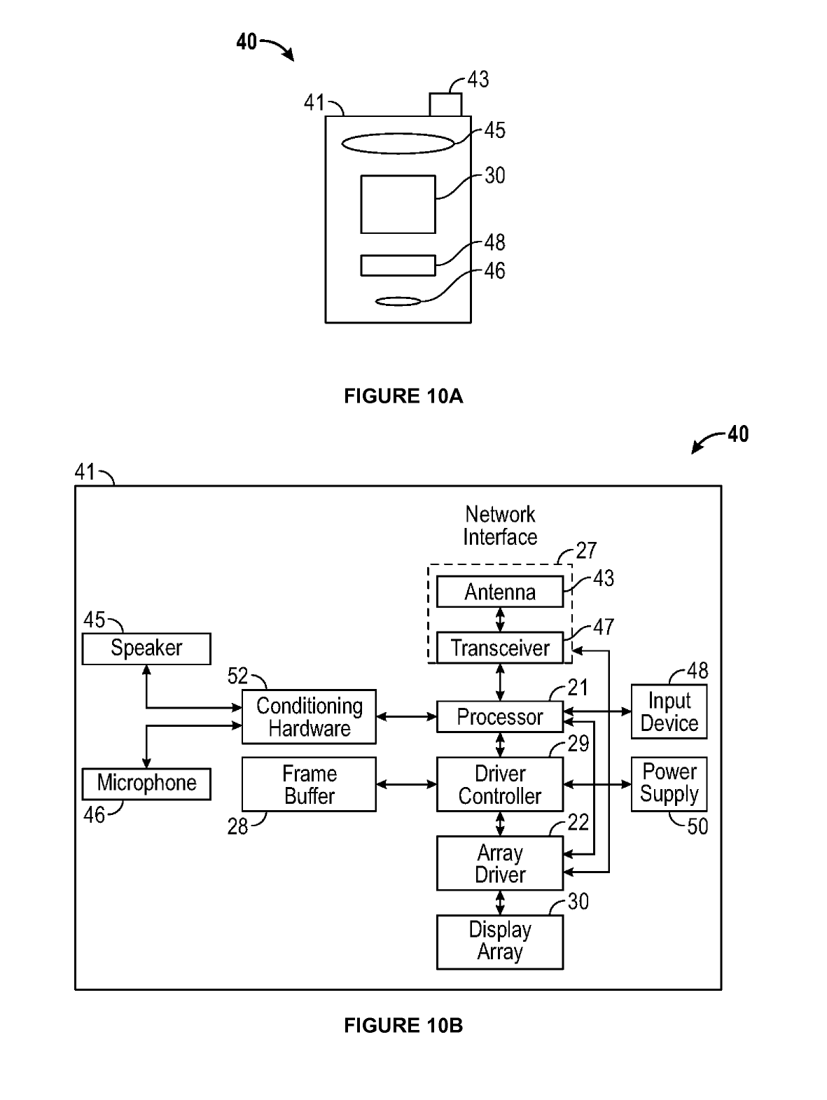

FIGS. 10A and 10B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display. The display 30 also can be configured to include a flat-panel display, such as plasma electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna. 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIGS. 7A and 7B, can be configured to function as a memory device and be configured to communicate with the processor 21. In some implementations, a power supply 50 can provide power to substantially all components in the particular display device 40 design.

The network interface 27 includes the antenna. 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RE signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RE signals according to the Bluetooth® standard. In the case of a cellular telephone, the antenna 43 can be designed to receive code division multiple access (CDMA), frequency division multiple access (FDMA), time division multiple access (TDMA); Global System for Mobile communications (GSM); GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a hi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, a-b, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus comprising:
a movable light blocking component;
a first beam electrode coupled to the movable light blocking component and capable of receiving a first voltage;
a second beam electrode capable of receiving a second voltage; and
a third beam electrode, wherein:
the third beam electrode has a greater degree of mechanical compliance than at least one of the first and second beam electrodes;
the third beam electrode is positioned between the second beam electrode and at least a portion of the first beam electrode; and
the third beam electrode is capable of receiving a third voltage;
wherein the first voltage is sufficiently different from at least one of the second voltage and the third voltage to cause the first, second, and third beam electrodes to be drawn substantially into contact with one another, thereby moving the movable light blocking component.

2. The apparatus of claim 1, wherein the first voltage is substantially similar to the second voltage.

3. The apparatus of claim 1, wherein the second beam electrode is substantially rigid.

4. The apparatus of claim 1, wherein the third beam electrode has a greater degree of mechanical compliance than both the first and second beam electrodes.

5. The apparatus of claim 1, wherein the first and second beam electrodes are electrically coupled to and supported over a substrate by a common anchor.

6. The apparatus of claim 1, wherein the first beam electrode includes a first portion positioned on a side of the third beam electrode opposite from the second beam electrode and a second portion positioned on a side of the second beam electrode opposite the third beam electrode.

7. The apparatus of claim 1, wherein the third beam electrode is positioned, in its rest position, approximately halfway between the first and second beam electrodes.

8. The apparatus of claim 1, wherein the movable light blocking component translates radially responsive to the first, second and third beam electrodes being drawn substantially into contact with one another.

9. The display apparatus of claim 1, further comprising:
a display;
a processor that is configured to communicate with the display, the processor being configured to process image data; and
a memory device that is configured to communicate with the processor.

10. The display apparatus of claim 9, further comprising:
a driver circuit configured to send at least one signal to the display; and
a controller configured to send at least a portion of the image data to the driver circuit.

11. The display apparatus of claim 9, further comprising:
an image source module configured to send the image data to the processor, wherein the image source module comprises at least one of a receiver, transceiver, and transmitter.

12. The display apparatus of claim 9, further comprising:
an input device configured to receive input data and to communicate the input data to the processor.

13. A method of actuating a movable light blocking component, comprising:
receiving, by a first beam electrode coupled to the movable light blocking component, a first voltage;
receiving, by a second beam electrode, a second voltage;
receiving, by a third beam electrode positioned between the second beam electrode and at least a portion of the first beam electrode, a third voltage, the third beam electrode having a greater degree of mechanical compliance than at least one of the first and second beam electrodes; and
moving the light blocking component by drawing the first, second, and third beam electrodes substantially into contact with one another responsive to the first voltage being sufficiently different from at least one of the second voltage and the third voltage.

14. The method of claim 13, wherein the first voltage is substantially similar to the second voltage, and the third voltage is sufficiently different from the first voltage and the second voltage.

15. The method of claim 13, wherein the third beam electrode has a greater degree of mechanical compliance than both the first and second beam electrodes.

16. The method of claim 13, comprising:
radially translating the movable light blocking component responsive to the first, second and third beam electrodes being drawn substantially into contact with one another.

17. An apparatus comprising:
a movable light blocking component configured to radially translate;
a first beam electrode coupled to the movable light blocking component and capable of receiving a first voltage;
a second beam electrode capable of receiving a second voltage; and
a third beam electrode capable of receiving a third voltage and positioned between the second beam electrode and at least a portion of the first beam electrode;
wherein the first voltage is sufficiently different from at least one of the second voltage and the third voltage to cause the first, second, and third beam electrodes to be drawn substantially into contact with one another, thereby radially translating the movable light blocking component.

18. The apparatus of claim 17, wherein the first voltage is substantially similar to the second voltage.

19. The apparatus of claim 17, wherein the third beam electrode has a greater degree of mechanical compliance than both the first and second beam electrodes.

20. The apparatus of claim 17, wherein the second beam electrode is substantially rigid.
